(19) United States
(12) Patent Application Publication
(10) Pub. No.: US 2008/0215371 A1
(43) Pub. Date: Sep. 4, 2008

(54) ELECTRONIC CHART APPARATUS AND A DIETARY INSTRUCTION SUPPORT METHOD

(75) Inventors: Masaru ASAKAWA, Tokyo (JP); Yoshihiro ITO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/040,195

(22) Filed: Feb. 29, 2008

(30) Foreign Application Priority Data
Mar. 2, 2007 (JP) 2007-052253

(51) Int. Cl. G06Q 50/00

(52) U.S. Cl. 705/3

(57) ABSTRACT

A main unit of an electronic chart apparatus is connected to a chart database, a medicament information database and a food information database through a LAN. The chart database contains chart data created based on medical records including a diagnosed injury or disease and drugs prescribed for this injury or disease. Based on the medical records on a patient, cautionary information on such foods that can give bad influence on the patient in relation to the diagnosed injury or disease is retrieved from the food information database, and also cautionary information on such foods that must be taken with caution about concomitant intake with the prescribed drugs is retrieved from the medicament information database. With reference to the results of retrieval, a dietary instruction is given to the patient, avoiding such foods that are indicated by the retrieved cautionary information.

### FIELD OF THE INVENTION

The present invention relates to an electronic chart apparatus digitizing and managing medical records and a method of supporting dietary instruction for patients.

### BACKGROUND OF THE INVENTION

In such medical facilities as hospitals and clinics, an electronic chart apparatus computerizing and controlling medical records from examination with patients, that is a chart, is well-known. Furthermore the electronic chart apparatus is getting highly-functional in order to respond to a multiple of user's needs. In addition to a main function of creating and controlling the chart, a representative function of additional ones is a prescription support function. The prescription support function is for example to search a medicament database storing medicament information based on an input inquiry about prescribed drugs for a patient, and to respond to the inquiry with cautionary information about the drugs. The cautionary information about the drugs includes cautions to be considered in prescription such as their side-effects, interactions and incompatible drugs. With the prescription support function, it is possible to easily check appropriateness of the prescribed drugs.

In recent years, demand for health foods and dietary supplements tends to increase with more health consciousness. In this background, more medical facilities are active in giving dietary instruction to patients. So it has been studied to provide the electronic chart apparatus with a function of supporting the dietary instruction as an additional function.

As a technology applicable to the dietary instruction support, there is a dietary service method shown in Japanese Laid-open Patent Application No. 2003-223515. The dietary service method is providing recommended foods for a client according to genetic information and cases of the client. The recommended foods are selected by taking account of various elements of the client, including its genetic information, cases and health condition, and analyzing them in detail.

For the dietary instruction in the medical facilities, however, it is more important to give caution about intake of some foods in relation to particular diseases and drugs than to suggest the recommended foods. There has been a problem that only a simple combination of conventional methods cannot offer appropriate dietary instruction. The conventional methods are analyzing various factors at large to select foods. Though the method of such analysis is not specifically clear, its composition is expected to be very complicated. Adopting the complicated method as an additional function to the electronic chart apparatus may probably go against the demand for low-cost production and simple constitution.

### SUMMARY OF THE INVENTION

In view of the foregoing, a primary object of the present invention is to provide an electronic chart apparatus and a dietary instruction support method, which can offer appropriate dietary instruction for a client without the need for any complicated structures.

According to the present invention, an electronic chart apparatus that digitizes and manages medical records on a patient, including a diagnosed injury or disease and prescribed drugs for the disease, comprises a device for accepting input of the medical records; a first storage device storing first cautionary information on such foods that must be taken with caution about concomitant intake with some drugs; a second storage device storing second cautionary information on such foods that must be taken with caution in relation to certain injuries and diseases; and a search section for retrieving the first and second cautionary information on foods from the first and second storage devices respectively based on the prescribed drugs and the diagnosed injury or disease included in the accepted medical records.

Preferably, the electronic chart apparatus further comprises a third storage device storing medicament information on drugs available for prescription to each individual injury or disease; and a search section for retrieving available drugs for prescription from the third storage device base on the diagnosed injury or disease included in the accepted medical records.

The electronic chart apparatus preferably comprises a display control device for displaying the retrieved first cautionary information on foods in relation to the respective drugs that are retrieved as available for prescription to the diagnosed injury or disease. The display control device also displays the retrieved second cautionary information on foods in relation to the diagnosed injury or disease.

According to a preferred embodiment, the electronic chart apparatus further comprises a judging device for judging suitability of a designated food for the patient on the basis of at least one of the first and second cautionary information on foods as retrieved respectively based on the prescribed drugs and the diagnosed injury or disease. It is preferable to provide the electronic chart apparatus with a fourth storage device storing information on recommended foods according to disease or drug; and a device for retrieving recommended foods based on the diagnosed injury or disease or the prescribed drugs, wherein the judging device judges suitability of the retrieved recommended foods for the patient by checking whether the recommended foods are included in the retrieved first or second cautionary information on foods.

A method of supporting dietary instruction of the present invention comprises steps of:

storing first cautionary information on such foods that must be taken with caution about concomitant intake with some drugs and second cautionary information on such foods that must be taken with caution in relation to certain injuries and diseases;

accepting input of medical records on a patient, including a diagnosed injury or disease and prescribed drugs for the disease; and

retrieving the first and second cautionary information on foods respectively based on the prescribed drugs and the diagnosed injury or disease included in the accepted medical records.

With the apparatus and method of the present invention, information on such foods that the patient should avoid taking with the prescribed drugs or in relation to the diagnosed injury or disease is retrieved based on the input medical records. So the present invention makes it easy to give an appropriate dietary instruction to the patient.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram illustrating an electronic chart apparatus according to an embodiment of the present invention;

FIG. 2 is an explanatory diagram illustrating medicament information stored in a medicament information database;

FIG. 3 is an explanatory diagram illustrating food information stored in a food information database;

FIG. 4 is an explanatory diagram illustrating a chart input screen;

FIG. 5 is an explanatory diagram illustrating a search result display screen;

FIG. 6 is a flowchart illustrating a sequence of processing for retrieving cautionary information on foods;

FIG. 7 is a block diagram illustrating an internal structure of a CPU according to another embodiment for making judgment on suitability of foods;

FIG. 8 is a flowchart illustrating a sequence of processing for judging suitability of foods; and

FIG. 9 is a flowchart illustrating a sequence of processing for giving nutritional instruction.

### DESCRIPTION OF THE PREFERRED EMBODIMENTS

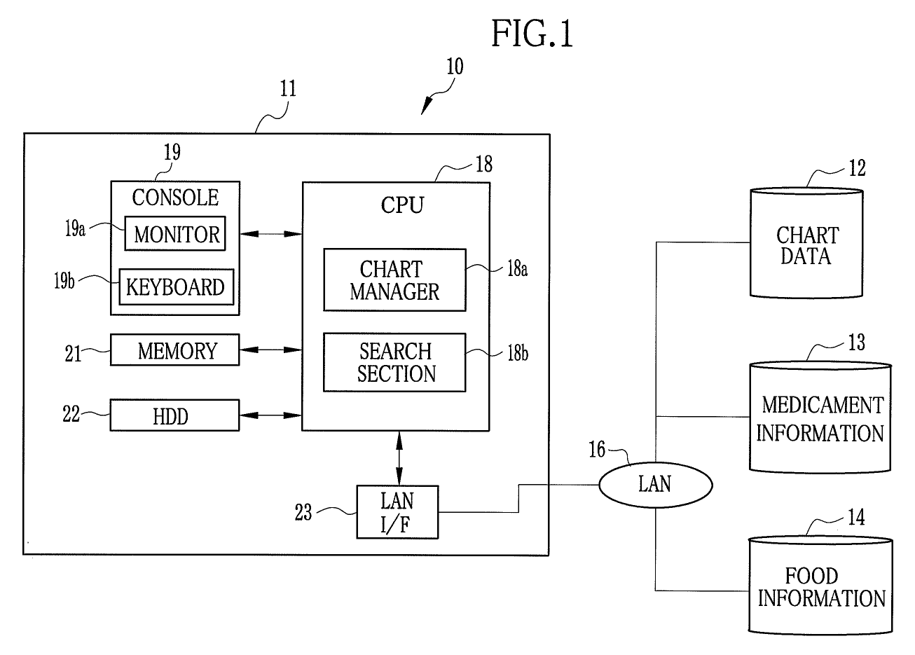

An electronic chart apparatus 10 shown in FIG. 1 is for creation and control of an electronic chart, that is, digitizing and managing medical records which include a record of a diagnosed injury or disease and a record of prescribed drugs for it. The electronic chart apparatus 10 is also provided with a prescription support function, searching for available drugs for prescription according to the diagnosed injury or disease, and with a dietary instruction support function of supporting dietary instruction for patients, searching for foods with caution against intake in relation to particular injuries, diseases and drugs.

The electronic chart apparatus 10 consists of a main unit 11, a chart database (DB) 12, a medicament information database 13 and a food information database 14. The main unit 11 is connected to the respective databases 12, 13 and 14 through for example a local area network (LAN) 16, so it is possible to access from the main unit 11 to the respective databases 12, 13 and 14.

Based in for example a personal computer or workstation, the main unit 11 is installed with a control program as an operating system and an electronic chart program as an application system, and provided with a CPU 18, a console 19, a memory 21, a hard disc drive (HDD) 22 and a LAN interface 23.

The CPU 18 controls the overall operation of every part of the main unit 11 with the running control program and functions as a chart manager 18a and a search section 18b as the electronic chart program starts up. The HDD 22, a well-known data storage device is stored with the control program, the electronic chart program and various data for running these programs. The memory 21 is a working memory for the CPU 18 to run the programs and the CPU 18 executes the program loading it in the memory 21 from the HDD 22.

The console 19 consists of a monitor 19a displaying an operation screen and chart data, and input devices such as a keyboard 19b and a mouse for inputting the data and operation commands. The LAN interface 23 controls communication via the LAN 16. The CPU 18 carries out display control of the display screen on the monitor 19a and reception control of the data and operation commands input from the input device.

The chart manager 18a accepts medical records that are input through a chart input screen displayed on the monitor 19a, creates the chart data based on the medical records and stores the created data in the chart database 12. The medical records include a diagnosis such as patient's indication, information on inspection and diagnosed names of disease, and a prescription indicating medicines prescribed according to the diagnosis. The chart manager 18a reads out the chart data from the chart database 12 based on search criteria such as a patient name or patient ID, to display the chart data on the monitor 19a. When update of the chart data is demanded, the demand is received and an updating process is performed. The search section 18b accesses the medicament information database 13 and the food information database 14 to retrieves medicament information and food information based on the search criteria.

The medicament information database 13 is a medicament information storage that stores drug names linking with target injuries or diseases of their potency. The medicament information includes information about interaction of drugs as cautionary information on prescription, like incompatible drugs of which combined use is prohibited and drugs with caution about concomitant use with other drugs and remarks about allergy, side-effect, etc.

In addition to the general cautionary information about drugs, the medicament information database 13 is also stored with information about such foods that must be taken with caution about concomitant intake with some drugs.

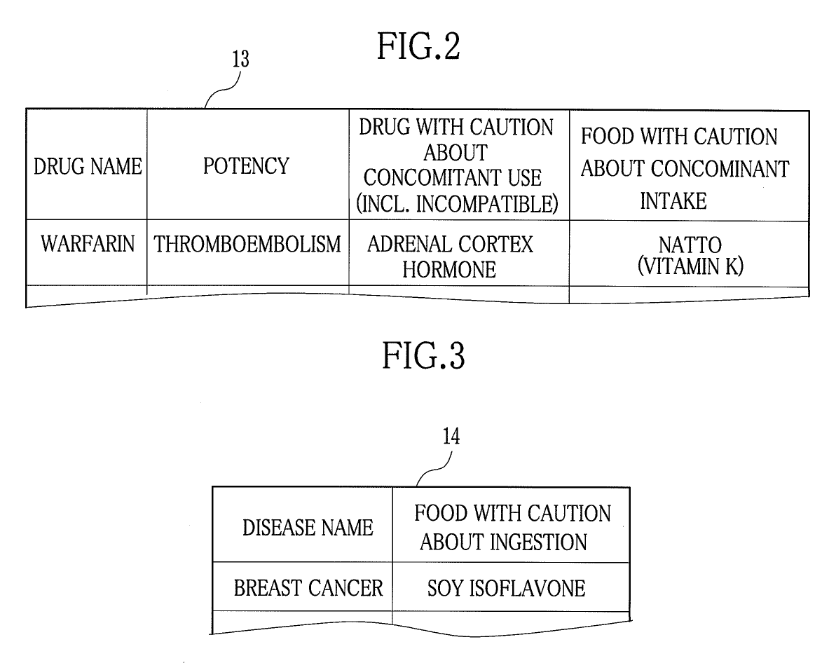

FIG. 2 illustrates an example of the medicament information stored in the medicament information database 13. In the case of warfarin, one of potent drugs to thromboembolism, an adrenal cortex hormone is cited as an example of a drug with caution about concomitant use with warfarin, and natto (fermented soy beans) including vitamin K is cited as a food with caution about concomitant intake with warfarin. On respective drugs, such information is stored in the medicament information database 13.

The food information database 14 is a storage device for the food information that includes such cautionary information that indicates risky foods for particular diseases, intake of which can badly affect on the patients. As shown for example in FIG. 3, soy isoflavone is cited as the risky food for breast cancer.

As described above, the medicament information database 13 and the food information database 14 store two kinds of cautionary information on foods: one is on those foods which must be taken with caution about concomitant use with particular drugs and the other is on those foods which can be risky for particular diseases. Based on the search criteria, the search section 18b accesses the medicament information database 13 to search for the foods with caution about concomitant intake with the drugs received as the search criteria, or accesses the food information database 14 to search for the foods with caution about intake regarding the disease received as the search criteria.

Hereby, the cautionary information on such foods that must be taken with caution about concomitant intake with some drugs, which is stored in the medicament information database 13, corresponds to a first cautionary information in the claim of the present invention, whereas the cautionary information on such foods that must be taken with caution with respect to some diseases, which is stored in the food information database 14, corresponds to a second cautionary information in the claim. According to this embodiment, one kind of cautionary information is stored in the medicament information database 13 and the other kind of cautionary information is stored in the food information database 14. As storing the first cautionary information as a part of the medicament information, the medicament information database 13 functions not only as medicament information storage but also as food information storage. However, the storage pattern of two kinds of cautionary information is not limited to this embodiment. It is also possible to store the cautionary information in more than two databases or to unit them into one database.

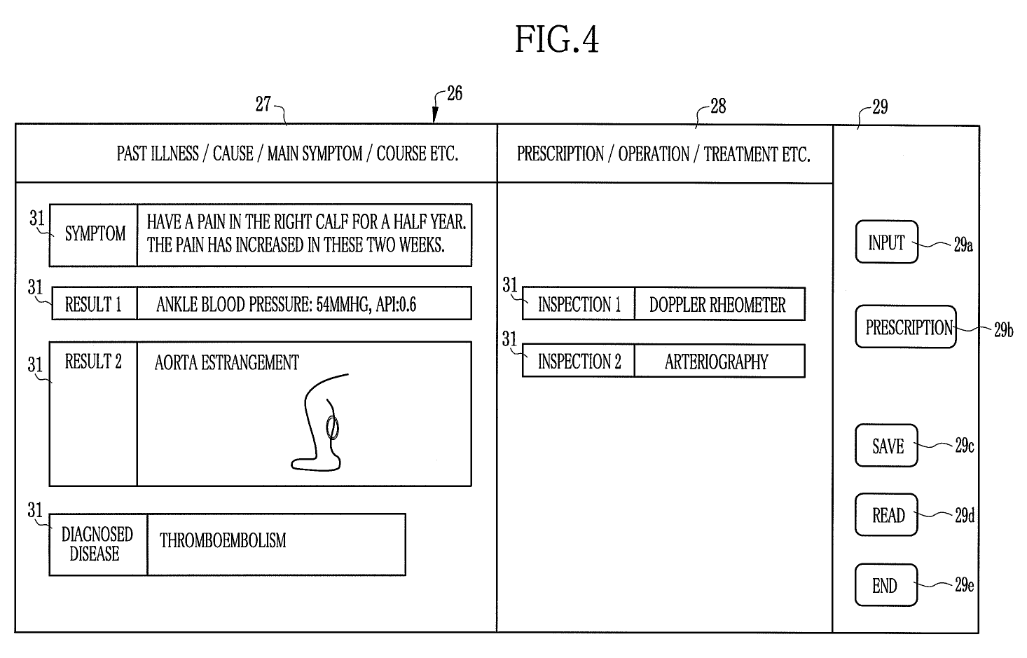

FIG. 4 illustrates an example of a chart input screen 26, which accepts the medical records as input through the console 19 and displays the input contents in a chart. A chart input screen 26 is mainly divided into two areas; a first area 27 displaying a past illness, major symptom, course, etc. and a second area 28 displaying records of prescription, medical operation, treatment, etc. Moreover, an operation panel 29 displaying operation buttons is provided next to the second area 28.

On the operation panel 29, an input button 29a, a prescription button 29b, a save button 29c, a reading button 29d and an end button 29e are arranged. The input button 29a is for inputting data. By clicking the input button 29a with the mouse or the like, data entry boxes 31 where data is to be input are displayed. Making the first area 27 active and clicking the input button 29a open the data entry boxes 31 in the first area 27. Making the second area 28 active and clicking the input button 29a open the data entry boxes 31 in the second area 28. The keyboard inputs the data into the data entry boxes 31. In this way, various data items including patient's indication, results of examinations, diagnosed injury or diseases and information on adopted inspections are input. The save button 29c is for entering a command to store the input data, upon which, the input data is stored in the chart database 12.

The reading button 29d is for giving a command to read out the chart data from the chart database 12. Clicking the reading button 29d displays a box for inputting criteria for specifying the chart data. Inputting a patient name and ID in this box specifies the desired chart data. The end button 29e is for ending the input of the chart data. Clicking the end button 29e closes the chart input screen 26.

The prescription button 29b is for executing a prescription support process to search for drugs. Upon clicking the prescription button 29b, the search section 18b searches for available drugs for prescription based on the input name of the diagnosed injury or disease. In the prescription support process, the search section 18b also accesses the medicament information database 13 and the food information database 14 to search for the cautionary information in addition to the drugs to be prescribed. The search results are displayed on the monitor 19a.

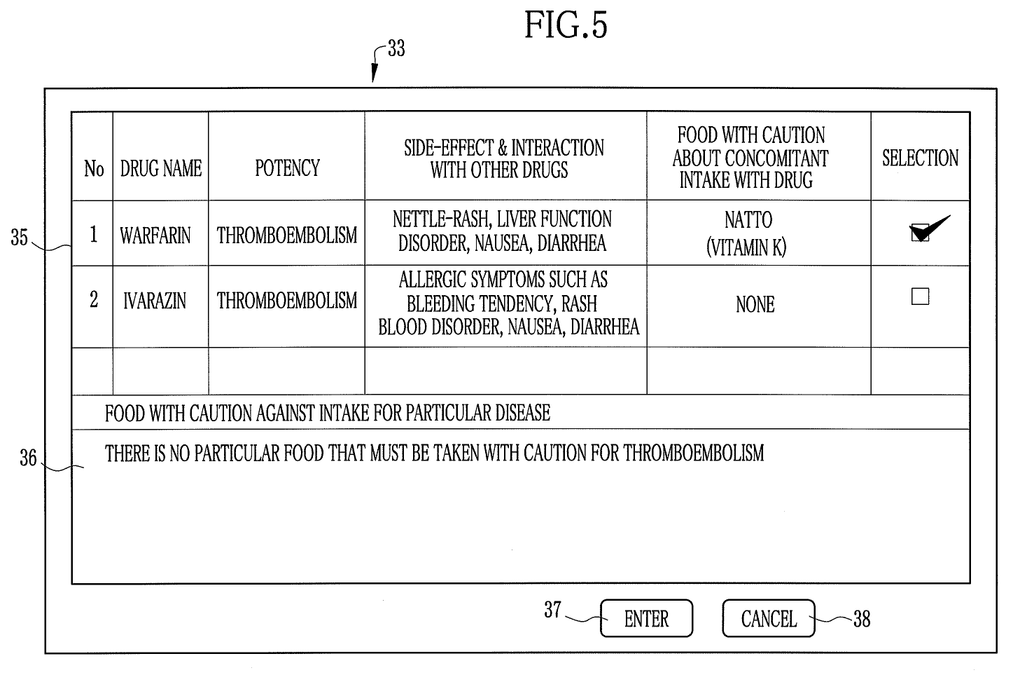

FIG. 5 illustrates an example of a screen displaying the result of the search. The search result display screen 33 is divided into for example an upper area 35 and a lower area 36. The upper area 35 is for displaying information read out from the medicament information database 13, and the lower area 36 is for displaying information read out from the food information database 14.

In the upper area 35, the names of available drugs for prescription are listed for example in tabular form. Display items include drug name, potency (the name of disease the drug is effective to), side-effect, and drug and food with caution about concomitant use. A check box for selecting the drug is displayed on the extreme right to each drug name. Checking either of the listed drugs at the check box means the input of the selection. In the lower area 36, the food risky to a particular disease is displayed. These cautioned foods can be displayed by their names or by their marked components such as vitamin K. It is also possible to display names of supplements which include the marked components or to display the marked components and supplements together. The supplement name can also be a general name or a name of its representative product.

An enter button 37 is for fixing the input selection of the drug. By clicking the fix button 37, the name of selected drug is entered on the chart input screen 26. A cancel button 38 is for ending the display screen of search result.

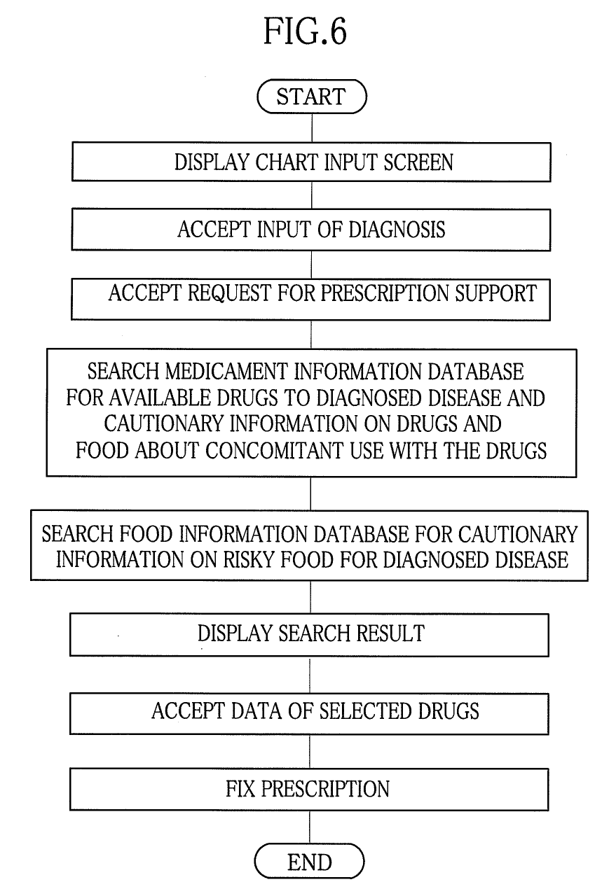

Now the operation of the above described embodiment will be explained while referring to a flowchart shown in FIG. 6. When the electronic chart program starts to run, the chart input screen 26 is displayed. Through the chart input screen 26, the input of contents of diagnosis including the name of diagnosed injury or disease is accepted. When a request for the prescription support is received, the prescription support process is executed. In the prescription support process, the search section 18b accesses the medicament information database 13 to search for the medicament information about available drug for prescription based on the diagnosed injury or disease as well as to read out the information on the foods that must be taken with caution as combined with particular drugs. And the search section 18b accesses the food information database 14 to search for the foods that can affect adversely regarding particular disease. After these searches, the search result display screen 33 displays the results of these searches.

The search result display screen 33 displays, besides general cautionary information about the prescribed drugs, the information on the foods marked with caution about intake in relation to the diagnosed injury or disease as well as on the foods marked with caution about concomitant intake with the prescribed drugs. Thus, the patient can get an instruction to keep off these cautioned or marked foods. When giving the patient an advice of foods recommendable from the viewpoint of nutritional balance, it is possible to make proposals for avoiding these marked foods. In this way, more proper instruction about foods than before can be achieved.

When the desired drug is selected from drugs listed in the search results, data of the selected drugs is received. Clicking the fix button 37 fixes the contents of prescription, and the chart input screen 26 reappears. The medical records including the content of prescription and diagnosis are stored in the chart database 12 as the chart data, in response to a command to store them.

In the above described embodiment, antagonistic foods are searched for from different points of view such as the relation between drug and disease and are displayed on the list as the search results. In addition to the search for the antagonistic foods, it is possible to provide another function to search for recommended foods that are beneficial to restoration from or prevention against particular diseases, so that both of these searches may be used selectively. Searching for the recommended foods makes it possible to counsel about nutrition.

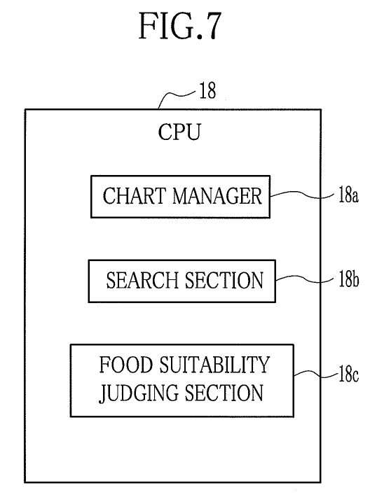

It is also possible to judge whether the patient can ingest certain food or not from the above-mentioned two viewpoints after receiving the input of the food name, not only searching and displaying the marked foods. In this case, for example, as shown in FIG. 7, the CPU 18 is made to function as a food suitability judging section 18c to determine whether the food can be ingested or not, in addition to the chart manager 18a and the search section 18b.

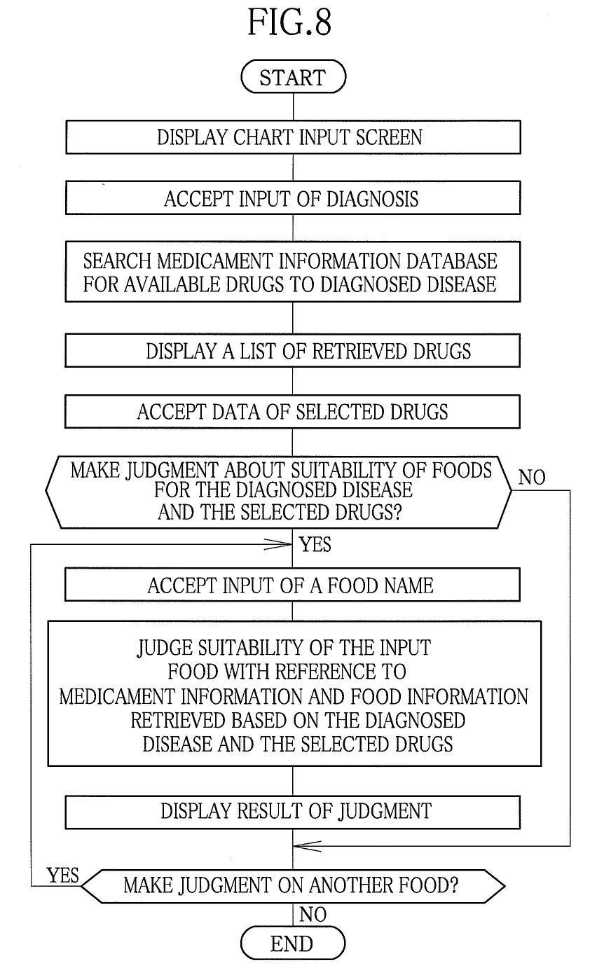

FIG. 8 is a flowchart illustrating a processing sequence of a food suitability judging process. In the same way as the above described embodiment, retrieved drugs are displayed in a list on a monitor 19a, after searching for available drugs for prescription based on a diagnosed injury or disease. After receiving information about which drug is selected from the list, it is asked whether to make the food suitability judgment or not. To make the food suitability judgment, an inquiry box is displayed on the monitor 19a to prompt input of the name of a food whose suitability is to be judged. When a food name got by hearing from a patient is input and a command to execute the food suitability judging process is given, the judging process starts for the input food.

The food suitability judging process is to access a medicament information database 13 to read out information on foods with caution about concomitant use from medicament information of the selected drug, and to access a food information database 14 to read out information on foods with caution about intake according to a diagnosed injury or disease. The food suitability judgment is made by checking the input food name with the information on these marked foods and by inspecting whether the input food name is included in these marked foods or not. When the input food name is included in the marked foods, unsuitability of this food is displayed as a judgment result. When the input food name is not included in these marked foods, a judgment that this food is suitable is displayed. When judging for another food, the above described steps are repeated. Herewith, it becomes easy to check the suitability of such foods that a patient daily eats or likes to eat in relation to the patient's disease and drugs prescribed for the patient.

Judging suitability of a given food is usable not only for the dietary instruction but also for example for unfolding the cause of food allergy, i.e. clarifying foods causing allergy.

In the above described food suitability judgment, the input food is judged whether it falls into the marked foods after searching for the foods with caution about intake in relation to a certain disease or drug. It is also possible to use the food suitability judgment for searching for the above-mentioned recommended food when giving nutrition instruction.

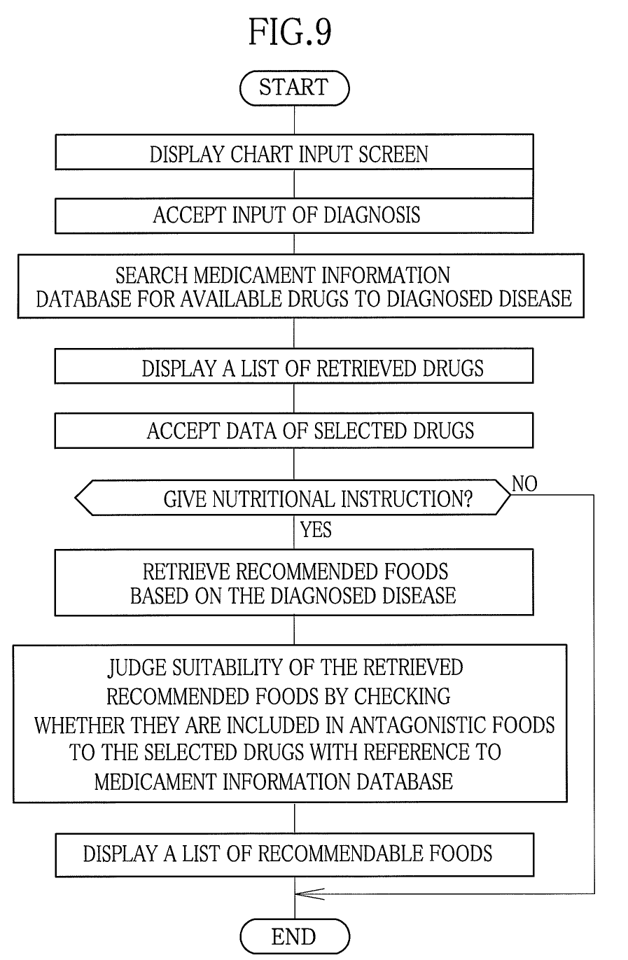

In this case, information regarding the above-mentioned recommended foods is previously stored in the food information database 14 in addition to the above described foods with caution about concomitant use with some drug and in relation to some disease. As shown in a flowchart in FIG. 9, after receiving information on the selected drugs, the search section 18b searches for the recommended foods based on the diagnosed injury or disease. The food suitability judging section 18c accesses the medicament information database 13 to read out the information on foods with caution about concomitant use with the selected drugs, checks it with the above-mentioned recommended foods, to examine whether the above-mentioned recommended foods are included in the foods marked with caution about concomitant use or not, and judges whether the recommended foods are suitable or not with respect to the selected drugs. If any of the recommended foods are judged to be unsuitable for the selected drugs, they are removed and only the recommended foods which are judged to be suitable for intake are picked out and displayed in the list.

In the above described embodiment, the foods with caution about concomitant use with the drugs are removed from the recommended foods for the disease. On the contrary, it is possible to remove the foods marked with caution in relation to the disease from foods recommended in relation to the drug, for example, foods including components which have good interaction with the drug.

In the above described embodiment, the marked foods are searched for in view of disease and drug. In addition to these searches, it is also possible to add a search for the marked foods in relation to such inspection results as DNA testing, to judge suitability of food for intake based also on this information.

In the above described embodiment, the electronic chart apparatus is provided with two functions: the prescription support and the dietary instruction support. It is, however, possible to provide the apparatus of the present invention with only the dietary instruction support function.

In the above described embodiment, the main unit is connected respectively to the chart database, the medicament information database and the food information database through the LAN in the electronic chart apparatus. Instead of connecting by the LAN, however, it is also possible to install the respective databases in data storage inside the main unit to configure the apparatus as a device independent of a network. As for the network, a wide area network such as the Internet is usable instead of the LAN. Moreover, it is also possible to configure the respective databases as a common database shared by a plurality of main units, to make up an electronic chart system consisting of the common database and the main units.

In the above described embodiment, the electronic chart apparatus is provided with the dietary instruction support function. It is, however, possible to separate the dietary instruction support function from the electronic chart apparatus, and configure an apparatus to be dedicated to the dietary instruction support. Although the present invention has been described with respect to the embodiments in the form of apparatus, the present invention may be embodied in the form of program.

Thus, the present invention is not to be limited to the above embodiments but, on the contrary, various modifications will be possible without departing from the scope of claims appended hereto.

What is claimed is:

1. An electronic chart apparatus that digitizes and manages medical records on a patient, including a diagnosed injury or disease and prescribed drugs for the disease, comprising:
a device for accepting input of the medical records;
a first storage device storing first cautionary information on such foods that must be taken with caution about concomitant intake with some drugs;
a second storage device storing second cautionary information on such foods that must be taken with caution in relation to certain injuries and diseases; and
a search section for retrieving the first and second cautionary information on foods from said first and second storage devices respectively based on the prescribed drugs and the diagnosed injury or disease included in the accepted medical records.

2. An electronic chart apparatus as recited in claim 1, further comprising:
a third storage device storing medicament information on drugs available for prescription to each individual injury or disease; and
a search section for retrieving available drugs for prescription from said third storage device base on the diagnosed injury or disease included in the accepted medical records.

3. An electronic chart apparatus as recited in claim 2, further comprising a display control device for displaying the retrieved first cautionary information on foods in relation to the respective drugs that are retrieved as available for prescription to the diagnosed injury or disease.

4. An electronic chart apparatus as recited in claim 3, wherein said display control device further displays the retrieved second cautionary information on foods in relation to the diagnosed injury or disease.

5. An electronic chart apparatus as recited in claim 2, further comprising a device for selecting at least a drug to be prescribed from among the available drugs retrieved from said third storage device.

6. An electronic chart apparatus as recited in claim 1, further comprising a judging device for judging suitability of a designated food for the patient on the basis of at least one of the first and second cautionary information on foods as retrieved respectively based on the prescribed drugs and the diagnosed injury or disease.

7. An electronic chart apparatus as recited in claim 6, further comprising:
a fourth storage device storing information on recommended foods according to disease or drug; and
a device for retrieving recommended foods based on the diagnosed injury or disease or the prescribed drugs, wherein said judging device judges suitability of the retrieved recommended foods for the patient by checking whether the recommended foods are included in the retrieved first or second cautionary information on foods.

8. A method of supporting dietary instruction comprising steps of:
storing first cautionary information on such foods that must be taken with caution about concomitant intake with some drugs and second cautionary information on such foods that must be taken with caution in relation to certain injuries and diseases;
accepting input of medical records on a patient, including a diagnosed injury or disease and prescribed drugs for the disease; and
retrieving the first and second cautionary information on foods respectively based on the prescribed drugs and the diagnosed injury or disease included in the accepted medical records.

9. A method of supporting dietary instruction as recited in claim 8, further comprising a step of judging suitability of a designated food for the patient on the basis of at least one of the first and second cautionary information on foods as retrieved respectively based on the prescribed drugs and the diagnosed injury or disease.

10. A method of supporting dietary instruction as recited in claim 9, further comprising steps of:
storing information on recommended foods according to disease or drug;
retrieving recommended foods based on the diagnosed injury or disease or the prescribed drugs; and
judging suitability of the retrieved recommended foods for the patient by checking whether the recommended foods are included in the retrieved first or second cautionary information on foods.
